(19) United States
(12) Patent Application Publication
(10) Pub. No.: US 2023/0202059 A1
(43) Pub. Date: Jun. 29, 2023

(54) CONVEYOR APPARATUS FOR A PRESS INSTALLATION

(71) Applicant: FAGOR ARRASATE, S.COOP., ARRASATE (ES)

(72) Inventors: Iban SAINZ GOMEZ, Arrasate - Mondragon (ES); Oier SARASUA MARITXALAR, Arrasate - Mondragon (ES); Aitor GARRO ARRILLAGA, Arrasate - Mondragon (ES); Alexander IGLESIAS RAMOS, Elgoibar (ES)

(21) Appl. No.: 18/088,876

(22) Filed: Dec. 27, 2022

(30) Foreign Application Priority Data
Dec. 27, 2021 (EP) 21383226.4

(51) Int. Cl. B25J 19/00; B25J 15/06; B21D 37/14

(52) U.S. Cl. CPC B25J 19/0091; B25J 15/0616; B21D 37/14

(57) ABSTRACT

A conveyor apparatus that includes a support, a crossbar and a plurality of tools attached to the crossbar. The crossbar is suitable for being moved to convey a workpiece and is supported only by the support. The crossbar includes first and second segments that are located on opposite sides of the support. First and second tools are respectively attached to the first and second segments. The conveyor apparatus includes at least one passive vibration compensation block attached to at least one element of the conveyor apparatus selected from the crossbar, the first tool, and the second tool, to reduce vibrations generated during the movement of the crossbar.

### CROSS-REFERENCE TO RELATED APPLICATIONS

This application relates to and claims the benefit and priority to European Application No. 21383226.4, filed Dec. 27, 2021.

### TECHNICAL FIELD

The present invention relates to conveyor apparatuses, in particular to conveyor apparatuses used in press installations comprising a plurality of stations and in which conveyor apparatuses are used for conveying workpieces between stations.

### BACKGROUND

Presses are used to shape workpieces such as metal sheets in order to give them the required shape by means of press strokes. In some cases, a plurality of pressing steps are required to obtain the final objects with the desired shape (such as parts of a vehicle, for example), so there are installations comprising a plurality of presses, each of said steps taking place in a different press of the installation. The presses can be of different types, and all the presses of one and the same installation can be of the same type or they can represent a combination of different types. The installations may comprise, in addition to presses, other stations in which the pieces are arranged for another repositioning, for example.

For example, the workpiece is arranged in a first station of a press installation for a pressing step, and once said step has ended, the workpiece is conveyed to another press for the next pressing step. These steps are repeated as many times as there are steps required in one and the same press installation, until completing the entire process and obtaining the desired object from the workpiece as a result. To convey workpieces from one press to another within one and the same installation, articulated arms, robots, or known conveyor apparatuses of another type are used.

The press or station receiving a workpiece comprises a support surface on which said workpiece is arranged, which can generally be a support surface of a lower die with a specific configuration. This support surface cooperates with another surface (of an upper die), and the workpiece is pressed between both surfaces thereby imparting to said workpiece the desired shape (which depends on the configuration of said surfaces). As a result, precision when placing a workpiece on the support surface is extremely important because if it is not accurately placed in the required position, the shape acquired after the corresponding pressing step may not be the required shape, and said workpiece must be disposed of. While conveying a workpiece by means of the corresponding conveyor apparatus, the workpiece may be exposed to undesired vibrations which may affect this described arrangement on the corresponding support surface. Vibrations are generated on the conveyor apparatus, or in the conveyor apparatus itself, which are transferred to the workpiece held by said conveyor apparatus. As a result, in addition to requiring a precise control over the actual conveyance of the workpiece (control over the movement provided by the conveyor apparatus), vibrations which may arise during said movement and may affect said placement of the workpiece should be taken into account.

Solutions which take these vibrations into account are already known. For example, EP0685276A1 discloses a conveyor apparatus configured for conveying workpieces from a first press to a second press of an installation of presses. The conveyor apparatus comprises two facing longitudinal guiding supports, a crossbar transverse to a first end associated with a first guiding support and a second end associated with a second guiding support, and a plurality of tools attached to the crossbar and each one comprising a plurality of suction cups suitable for holding the workpiece to be conveyed. The transverse crossbar is moved from one press to the other press guided by the guiding supports in a forward movement direction. This configuration of the conveyor apparatus allows a reduction of vibrations, due to the stabilization provided by the longitudinal guiding supports. However, it is not enough, and sensors are incorporated for detecting possible vibrations that may be generated. The sensors are communicated with a control unit, and the control unit incorporates in the control over the movement of the conveyor apparatus the signals received from said sensors in order to take them into account and try to correct the movement to eliminate or mitigate the generation of vibrations. Although it is a good solution a priori, this manner of acting may delay control, so there is not a precise monitoring of the path of the conveyor apparatus.

### SUMMARY

Disclosed is a conveyor apparatus for a press installation and a press installation.

The press installation of the invention comprises at least a first station and a second station arranged downstream of the first station in a forward movement direction, and the conveyor apparatus is configured for conveying a workpiece from the first station to the second station.

The conveyor apparatus of the invention comprises a support, a crossbar that comprises a longitudinal axis and that is attached to the support, and at least a first tool and a second tool attached to the crossbar and comprising a respective longitudinal axis, each tool comprising a plurality of suction cups for holding the workpiece to be conveyed. The crossbar is suitable for moving at least in the forward movement direction between the first station and the second station for conveying the workpiece between said stations.

The crossbar is supported only by the support and is attached to the support such that said crossbar comprises a first segment on one side of the support and a second segment on the other side of said support. The first tool is attached to the first segment of the crossbar and the second tool is attached to the second segment of the crossbar. This configuration of the conveyor apparatus causes the crossbar not to be supported at the ends thereof, as occurs in the state of the art, such that the first segment and the second segment are cantilevered.

The conveyor apparatus comprises at least one compensation block attached to at least one element of the conveyor apparatus selected from the crossbar, the first tool, and the second tool. Said compensation block comprises a configuration which passively and at least partially compensates for the vibrations generated at least in the element to which it is attached during the movement of the crossbar, such that the vibrations reaching the workpiece are reduced or eliminated.

Therefore, vibrations which may be transmitted to the workpiece are at least partially compensated for with the compensation block, and this is particularly useful when the workpiece is to be placed in the second station or when a workpiece is to be picked up from the first station, and this is achieved avoiding the problems from the state of the art related to the loss of monitoring of the path of the conveyor apparatus by the control over said path, as no control whatsoever in relation to vibrations is required, such that said path is kept as required or programmed at all times, while at the same time solving the problem derived from vibrations.

These and other advantages and features will become apparent in view of the figures and detailed description.

### DESCRIPTION OF THE DRAWINGS

FIG. 1 shows a press installation with a plurality of stations and, between each two stations, an embodiment of a conveyor apparatus.

FIG. 2 shows a plan view of the installation of FIG. 1.

FIG. 3 shows a perspective view of an embodiment of the conveyor apparatus.

FIG. 4 shows part of the conveyor apparatus of FIG. 3.

FIG. 4 shows a plan view part of the conveyor apparatus of FIG. 3, without tools.

FIG. 5 schematically shows a compensation block of the conveyor apparatus of FIG. 3.

FIG. 6 schematically shows a crossbar of the conveyor apparatus of FIG. 3, with two compensation blocks.

FIG. 7 shows another embodiment of a conveyor apparatus according to the invention.

### DETAILED DISCLOSURE OF THE INVENTION

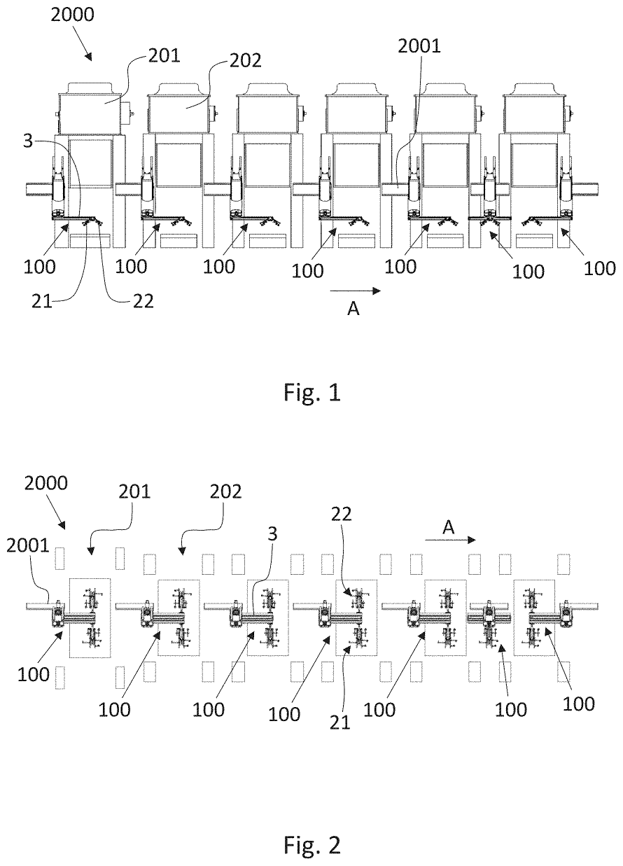

The press installations 2000, as the one shown by way of example in FIGS. 1 and 2, comprise a plurality of stations distributed in a forward movement direction A, and the conveyor apparatus 100 of the invention is suitable for conveying workpieces at least between said stations. In at least one of these stations, the installation 2000 comprises a press for performing a pressing operation on the workpiece, in which said workpiece is caught between an upper die and a lower die of said station.

The installation 2000 preferably comprises a conveyor apparatus 100 for conveying workpieces between each two stations. A conveyor apparatus 100 is therefore configured for conveying a workpiece between a first station 201 and a second station 202 arranged downstream of the first station 201 in a forward movement direction A of a press installation 2000. The conveyor apparatus 100 is associated with a structure 2001 of the installation 2000, and said installation 2000 preferably comprises a structure 2001 between every two presses 201 and 202 to support a conveyor apparatus 100.

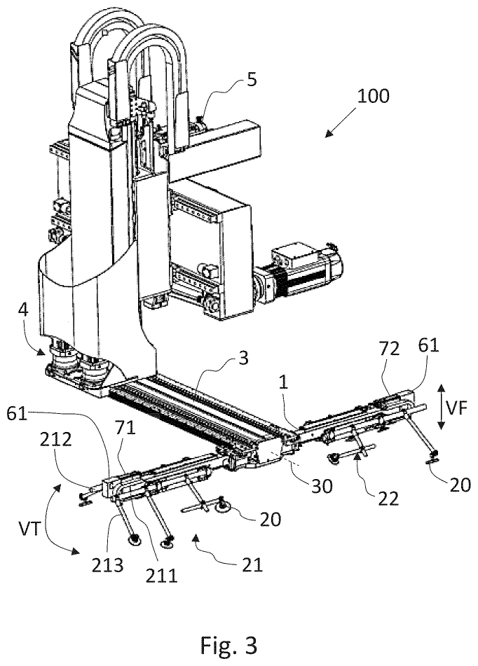

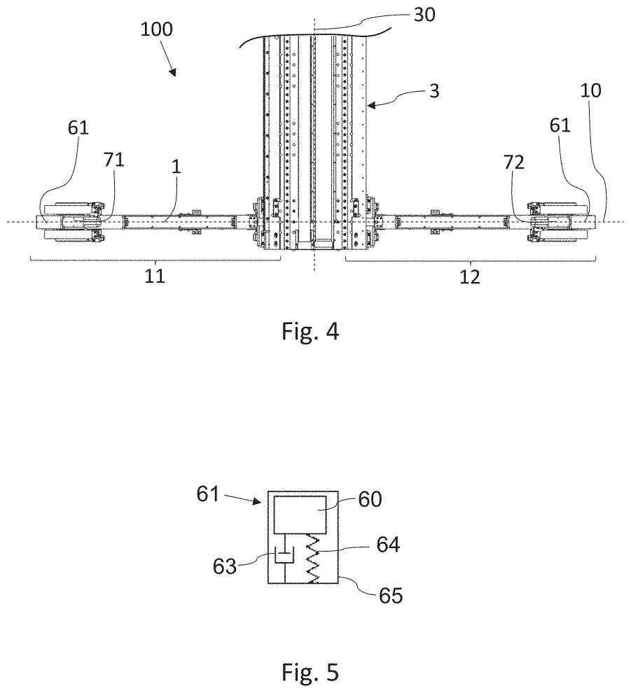

FIGS. 3 and 4 show an embodiment of the conveyor apparatus 100. Said conveyor apparatus 100 comprises a support 3, a crossbar 1 that comprises a longitudinal axis 10 and that is attached to the support 3, and at least a first tool 21 and a second tool 22 attached to the crossbar 1 and comprising a respective longitudinal axis. Each tool 21 and 22 comprises a plurality of suction cups 20 for holding the workpiece to be conveyed, and the crossbar 1 is suitable for moving at least in the forward movement direction A and between the first station 201 and the second station 202, for conveying the workpiece between said stations 201 and 202.

In the embodiment of FIGS. 3 and 4, the first tool 21 (like the second tool 22) comprises two longitudinal bars 211 and 212, extending in parallel to the longitudinal axis 10 of the crossbar 1, each longitudinal bar being attached on one side of the crossbar 1 in the forward movement direction A. Furthermore, the first tool 21 (like the second tool 22) comprises a plurality of arms 213 extending from each of the longitudinal bars 211 and 212, each arm 213 comprising a suction cup 20 preferably associated at its end farthest away from the corresponding longitudinal bar 211 and 212. The longitudinal axis of a tool 21 and 22 can be interpreted as the longitudinal axis of any of the longitudinal bars 211 and 212, for example, or another longitudinal axis centered with respect to said longitudinal bars and parallel to said longitudinal bars (in which case it would coincide with the longitudinal axis 10 of the crossbar 1).

The crossbar 1 is supported only by the support 3 and is attached to the support 3 such that said crossbar 1 comprises a first segment 11 on one side of the support 3 and a second segment 12 on the other side of said support 3. Both segments 11 and 12 of the crossbar 1 are thereby not supported (with the exception of the association with the support 3) and are cantilevered. The length of both segments 11 and 12 is preferably the same. Both segments 11 and 12 are aligned, sharing the longitudinal axis 10. The crossbar 1 can be a single element attached to the support 3, or both segments 11 and 12 can be two different elements attached to the support 3.

The first tool 21 is attached to the first segment of the crossbar 1, and the second tool 22 is attached to the second segment 12 of the crossbar 1, such that the workpiece can be picked up uniformly as required, or even more than one workpiece can be picked simultaneously (one with each tool 21 and 22, for example).

The conveyor apparatus 100 further comprises at least one compensation block 61 attached to at least one element of the conveyor apparatus 100 selected from the crossbar 1, the first tool 21 and the second tool 22. Said compensation block 61 comprises a configuration which passively and at least partially compensates for the vibrations generated at least in the element to which it is attached during the movement of the crossbar 1. Since the vibrations of these elements are translated to the workpiece held by the conveyor apparatus 100, eliminating or reducing these vibrations has a positive effect on the workpiece, and said workpiece is placed more securely where required. Likewise, the operation of picking up a workpiece is also performed in a more secure manner. The arrangement of the suction cups 20 is previously set depending on the workpiece to be picked up, so eliminating or reducing these vibrations allows the suction cups 20 of the conveyor apparatus 100 to be in the required position when holding the workpiece in a more precise manner.

Using a compensation block 61 that passively reduces or eliminates vibrations involves an absence of sensors and control over the compensation or elimination of vibrations, which prevents the problems of the state of the art relating to the loss of monitoring of the path of the conveyor apparatus 100, such that said path is kept under control at all times.

The compensation block 61 is preferably fixed to the corresponding element of the conveyor apparatus 100 by means of a structure 65, said compensation block 61 comprising, in addition to the structure 65, a floating mass 60, at least one damper 63 associated with the structure 65 and with the floating mass 60, and at least one elastic element 64 fixed to the floating mass 60 and to the structure 65 (and between said floating mass and said structure 65), as depicted schematically and by way of example in FIG. 5. The arrangement of the damper 63 is such that it cooperates in line with the elastic element 64 (in the same direction).

When the element to which the compensation block 61 is attached vibrates, due to the effect of the elastic element 64 and of the damper 63, the mobile mass 60 tends to absorb said vibration (at least partially).

The weight of the mobile mass 60 depends on the total mass of the conveyor apparatus 100, for example, although the workpiece to be conveyed and other elements of the installation could also be considered if deemed appropriate. The same occurs with the characteristics of the damper 63 and of the elastic element 64.

The elastic element 64 can be arranged perpendicular to the longitudinal axis of the element of the conveyor apparatus 100 to which the compensation block 61 is attached. When in standby, the crossbar 1 is arranged horizontally, with its longitudinal axis 10 as well as the longitudinal axis of the tools 21 and 22, being horizontal, such that as a result of the arrangement of the elastic element 64, the compensation block 61 can at least partially compensate for vertical or horizontal vibrations. The elastic element 64 preferably extends vertically, such that the compensation block 61 at least partially compensates for vertical vibrations. During a vertical movement of the crossbar 1, the main vibrations generated are bending vibrations VF and torsional vibrations VT (see FIG. 3), which affect the crossbar 1 and the tools 21 and 22, and the embodiment corresponding to the configuration of the compensation block 61 is preferably devised for at least partially compensating for torsional vibrations VT. The center of the torsional vibrations VT is located at the center of the crossbar 1 (in terms of its longitudinal axis 10), i.e., at the center of the support 3 at the height of the crossbar 1.

In some embodiments, the damper 63 is a magnetic damper (not depicted in the figures) and comprises at least one magnet fixed to the mobile mass 60 and a metallic element fixed to the structure 65 of the compensation block 61, said metallic element preferably being a copper element. When the element to which the compensation block 61, 62 is attached vibrates, a magnetic field is generated between the magnet and the metallic element attached to the mobile mass 60, which field, together with the effect of the elastic element 64, helps the mobile mass 60 assembly at least partially compensate for vibrations.

In other embodiments, the damper 63 and the elastic element 64 are arranged in parallel, said damper 63 being an element fixed between the floating mass 60 and the structure 65 of the compensation block 61. The damper 63 can be a hydraulic or another known type of damper.

Preferably, in any of the embodiments, the elastic element 64 has a linear behavior and can be, for example, a spring.

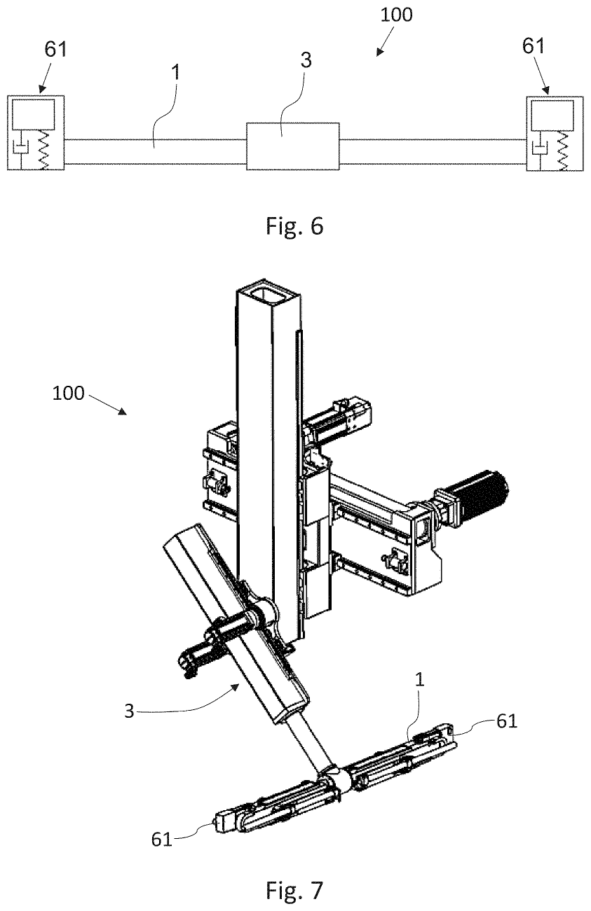

Preferably, as in the case of the embodiment shown in the figures, the element to which the compensation block 61 is attached is the crossbar 1. Furthermore, the conveyor apparatus 100 preferably comprises a first compensation block 61 attached to the first segment 11 of the crossbar 1 and a second compensation block 61 attached to the second segment 12 of said crossbar 1, as depicted schematically and by way of example in FIG. 6. The compensation for vibrations is thereby performed in a balanced manner, such that the two tools 21 and 22 are compensated for in the same way, which has a positive effect on the overall compensation and also on the size and arrangement of the compensation blocks 61. In the event of using a single compensation block 61, a larger floating mass 60 may need to be used, which would also involve having to increase sizes of the damper 63 and of the elastic element 64, and could hinder the arrangement of the compensation block 61. Using two compensation blocks 61 allows the necessary mass to be distributed between the two, having two compensation blocks 61 that have smaller dimensions and are easier to arrange in the conveyor apparatus 100.

In these cases, furthermore, the first compensation block 61 and the second compensation block 61 are preferably attached to the side of a respective end of the crossbar 1, as depicted in FIG. 6. In this arrangement, the mobile mass 60 to be used is smaller than in another arrangement because the center of the main vibrations to be compensated for is in the support 3.

The conveyor apparatus 100 may further comprise a first tool actuator 71 attached to the crossbar 1 for being able to move the first tool 21 with respect to the crossbar 1 (in a direction parallel to the longitudinal axis 10 of the crossbar 1) and a second tool actuator 72 attached to the crossbar 1 for being able to move the second tool 22 with respect to the crossbar 1 (in the direction parallel to the longitudinal axis 10 of the crossbar 1). This allows the tools 21 and 22 to be adjusted depending on the shape of the workpiece to be conveyed. In these cases, the first tool actuator 71 can be arranged above the crossbar 1 (attached to the first segment 11 of the crossbar 1), and the second tool actuator 72 can be arranged above the crossbar 1 (attached to the second segment 12 of the crossbar 1). With this arrangement of the actuators 71 and 72, it is thereby possible to arrange the compensation blocks 61 on the sides of the crossbar 1 in a simple manner since said ends are free, as described earlier.

In some cases, each tool 21 and 22 may comprise at least one compensation block 61 such as those described above, preferably two: one at each end (attached to the corresponding side). The conveyor apparatus 100 may further comprise at least one compensation block 61 in the crossbar 1 and at least one compensation block 61 in each tool 21 and 22.

In some embodiments, such as the one shown in the figures, the support 3 is a beam which is configured for being attached to a structure of the press installation 2000 with which the conveyor apparatus 100 is associated with freedom of movement. The support 3 comprises a longitudinal axis 30 extending in the forward movement direction A and transverse to the longitudinal axis 10 of the crossbar 1. The conveyor apparatus 100 comprises a first linear actuator 4 (shown in FIG. 3) configured for longitudinally moving the crossbar 1 with respect to the support 3 in the forward movement direction A, and a second linear actuator 5 (shown in FIG. 3) configured for causing the vertical movement of the support 3 and, therefore, of the crossbar 1 integral with said support 3, and the compensation block 61 comprises a configuration which passively and at least partially compensates for the vibrations generated at least in the element of the conveyor apparatus 100 to which it is attached during the movement of the crossbar 1. The compensation block 61 is preferably configured for at least partially compensating for the vibrations generated at least in the element to which it is attached during the vertical movement of the crossbar 1 when vertical movement of the support 3 is caused with the second linear actuator 5.

In other embodiments, the support 3 is an articulated arm (see FIG. 7) or a robot attached to a structure of the installation 2000 with which the conveyor apparatus 100 is associated. In these cases, the movement of the articulated arm (or robot) is caused to generate the required movement of the crossbar 1 for conveying the workpiece.

What is claimed is:

1. A conveyor apparatus for a press installation, the press installation comprising a first station and a second station located downstream the first station in a forward movement direction, the conveyor apparatus being configured to convey at least one workpiece from the first station to the second station, the conveyor apparatus comprising;
a support;
a crossbar attached only to the support and having a first longitudinal axis, the crossbar being movable at least in the forward movement direction between the first station and the second station, the crossbar having a first segment located on a first side of the support and a second segment located on a second side of the support;
a first tool attached to the first segment of the crossbar, the first tool having a second longitudinal axis and at least one suction cup configured to hold the workpiece;
a second tool attached to the second segment of the crossbar, the second tool having a third longitudinal axis and having at least one suction cup configured to hold the workpiece; and
a first passive vibration compensation block attached to an element selected from the group consisting of the crossbar, the first tool, and the second tool, the first passive vibration compensation block being configured to passively reduce vibrations generated in the element to which it is attached when the crossbar moves from the first station to the second station.

2. The conveyor apparatus according to claim 1, wherein the first passive vibration compensation block includes a structure containing a floating mass, a damper and an elastic element, the elastic element being fixed to the floating mass and to the structure.

3. The conveyor apparatus according to claim 2, wherein the first passive vibration compensation block is attached to the crossbar, the elastic element being arranged perpendicular to the first longitudinal axis.

4. The conveyor apparatus according to claim 2, wherein the first passive vibration compensation block is attached to the first tool, the elastic element being arranged perpendicular to the second longitudinal axis.

5. The conveyor apparatus according to claim 2, wherein the first passive vibration compensation block is attached to the second tool, the elastic element being arranged perpendicular to the third longitudinal axis.

6. The conveyor apparatus according to claim 3, wherein the first longitudinal axis extends horizontally and the elastic element of the passive vibration compensation block extends vertically.

7. The conveyor apparatus according to claim 4, wherein the second longitudinal axis extends horizontally and the elastic element of the passive vibration compensation block extends vertically.

8. The conveyor apparatus according to claim 5, wherein the third longitudinal axis extends horizontally and the elastic element of the passive vibration compensation block extends vertically.

9. The conveyor apparatus according to claim 2, wherein the damper is a magnetic damper and comprises at least one magnet fixed to the mobile mass and a metallic element fixed to the structure.

10. The conveyor apparatus according to claim 2, wherein the damper and the elastic element are arranged in parallel to one another, the damper being an element fixed between the floating mass and the structure.

11. The conveyor apparatus according to claim 1, wherein the first passive vibration compensation block is attached to the first segment of the crossbar and a second passive vibration compensation block is attached to the second segment of the crossbar.

12. The conveyor apparatus according to claim 11, wherein the first and second passive vibration compensation blocks are identical in structure to one another.

13. The conveyor apparatus according to claim 11, wherein the first passive vibration compensation block is attached to an end of the first segment furthest from the support, and the second passive vibration compensation block is attached to an end of the second segment furthest from the support.

14. The conveyor apparatus according to claim 13, further comprising a first tool actuator attached to the first segment and configured to move the first tool with respect to the first segment in a direction parallel to the first longitudinal axis, and a second tool actuator attached to the second segment and configured to move the second tool with respect to the second segment in the parallel direction to the first longitudinal axis.

15. The conveyor apparatus according to claim 14, wherein the first tool actuator is arranged above the first segment and the second tool actuator is arranged above the second segment.

16. The conveyor apparatus according to claim 1, wherein the support is an articulated arm configured to be coupled to a structure of the press installation.

17. The conveyor apparatus according to claim 1, wherein the support is a robot configured for being attached to a structure of the press installation.

18. The conveyor apparatus according to claim 1, wherein the support is a beam configured to be attached to a structure of the press installation, the beam having a fourth longitudinal axis extending in the forward movement direction and transverse to the first longitudinal axis of the crossbar, the conveyor apparatus further comprising a first linear actuator configured to longitudinally move the crossbar with respect to the support in the forward movement direction and a second linear actuator configured to move the support vertically.

19. The conveyor apparatus according to claim 18, wherein the first passive vibration compensation block is configured to reduce vibrations generated in the element to which it is attached during a vertical movement of the crossbar when vertical movement of the support is caused by the second linear actuator.

20. A press installation comprising:
a first station;
a second station arranged downstream of the first station in a forward movement direction, at least one of the first and second stations being a press station configured to perform a pressing operation on a workpiece;
a conveyor apparatus configured to convey the workpiece from the first station to the second station, the conveyor apparatus comprising:
a support;
a crossbar attached only to the support and having a first longitudinal axis, the crossbar being movable at least in the forward movement direction between the first station and the second station, the crossbar having a first segment located on a first side of the support and a second segment located on a second side of the support;
a first tool attached to the first segment of the crossbar, the first tool having a second longitudinal axis and at least one suction cup configured to hold the workpiece;
a second tool attached to the second segment of the crossbar, the second tool having a third longitudinal axis and having at least one suction cup configured to hold the workpiece; and
a first passive vibration compensation block attached to an element selected from the group consisting of the crossbar, the first tool, and the second tool, the first passive vibration compensation block being configured to passively reduce vibrations generated in the element to which it is attached when the crossbar moves from the first station to the second station.
